(19) United States
(12) Patent Application Publication
(10) Pub. No.: US 2003/0182843 A1
(43) Pub. Date: Oct. 2, 2003

(54) Methods and apparatus for rigging a fishing lure

(76) Inventors: Gary Donald Smart, Florissant, MO (US); Steven Craig Tomasi, St. Charles, MO (US)

Correspondence Address: John S. Beulick, Armstrong Teasdale LLP, Suite 2600, One Metropolitan Sq., St. Louis, MO, 63102, US

(21) Appl. No.: 10/114,567

(22) Filed: Apr. 2, 2002

(51) Int. Cl. A01K 83/06

(52) U.S. Cl. 43/44.2

(57) ABSTRACT

A rigging harness for a fishing lure includes a single wire that includes an eye-loop and at least one loop. The loop is axially spaced from the eye-loop. The rigging harness is configured to be inserted at least partially within the fishing lure such that the eye-loop extends outwardly from the fishing lure when the rigging harness is secured to the lure.

### BACKGROUND OF THE INVENTION

This invention relates generally to fishing equipment and more particularly, to methods and apparatus for rigging a fishing lure.

Many different baits are available for angler fishermen, including a variety of artificial lures. At least some known artificial lures include flexible fish-shaped bodies to which fishing paraphernalia, including hooks and weights may be attached. More specifically, at least one known fishing lure system includes a single hook that is inserted into the mouth of the lure and is extended outwardly through the back of the lure. Weights and other enhancements, such as spinners, are attached to the fishing line before the line is tied to the hook near the lure mouth.

However, inserting a hook through a fishing lure body without creating undesirable tears in the lure body may be a time-consuming and tedious task. Additionally, the alignment of the weights and enhancements with respect to the lure body, and/or the relative position of the hook with respect to the lure body, may cause the lure to twist when being retrieved with a reel when fishing. Twisting the lure presents an unnatural presentation of the lure, and depending on the severity of the twist, the line may become knotted in the reel. Furthermore, changing the weights after the fishing lure has been rigged may also be time-consuming task.

To facilitate aligning the bait with respect to the hooks and enhancements, and to enable treble hooks to be attached to such artificial lures, at least one known fishing lure uses a frame that is mounted externally around the bait or lure body. More specifically, the frame is fabricated from a plurality of wires that are coupled together to define a cavity. A separate plurality of wires are also attached to the frame to form loops to enable fishing enhancements to be coupled to the frame. Although the frame maintains the alignment of the bait to the frame, the size of the lure that may be used is limited by the size of the frame. Additionally, the external frame mars the natural appearance any fish-shaped lures that may be inserted within the frame cavity and prevents such lures from “swimming” in a natural manner when retrieved. Furthermore, because a plurality of wires are coupled together, each coupling location provides a potential weak link that may fail over time.

### BRIEF SUMMARY OF THE INVENTION

In one aspect, a rigging harness for a fishing lure is provided. The rigging harness comprises a single wire comprising an eye-loop and at least one loop. The loop is axially spaced from the eye-loop. The rigging harness is configured to be inserted at least partially within the fishing lure such that the eye-loop extends outwardly from the fishing lure when the rigging harness is secured to the lure.

In another aspect, a fishing lure system is provided. The fishing lure system comprises a lure and a rigging harness. The lure comprises comprising a fish-shaped body comprising a mouth, a tail, and a body extending therebetween. The body comprises a back surface and a lower surface, and has a cavity defined therein. The rigging harness is configured to couple the lure to a line, and comprises a single wire comprising an eye-loop and at least one loop. The loop is axially spaced from the eye-loop. The rigging harness is inserted partially within the lure cavity such that the eye-loop extends outwardly from the lure mouth when the rigging harness is coupled to the lure.

In a further aspect of the invention, a method for fabricating a fishing lure system is provided. The method comprises providing a fishing lure having a fish-like body including a mouth and a tail, forming a rigging harness from a single wire to include an eye-loop and at least one loop that is axially-spaced from the eye-loop, inserting the rigging harness within the fishing lure, and coupling the rigging harness to the lure such that the eye-loop extends outwardly from the fishing lure mouth and the at least one loop extends outwardly from the lure body.

In yet a further aspect of the invention, a fishing hook is provided. The fishing hook comprises a shaft portion, a hook portion, and a weight-coupling portion. The hook portion extends from the shaft portion and comprises a plurality of hooks that extends outwardly from the hook portion. The weight is configured to removably couple to the shaft portion that the weight extends substantially coaxially from the shaft portion.

### BRIEF DESCRIPTION OF THE DRAWINGS

FIG. 1 is a cross-sectional view of one embodiment of a fishing lure system;

FIG. 2 is a cross-sectional view of an alternative embodiment of a fishing lure system;

FIG. 3 is a cross-sectional view of an alternative embodiment of a fishing lure system;

FIG. 4 is a cross-sectional view of an alternative embodiment of a fishing lure system;

FIG. 5 is a side view of a treble hook that may be used with the fishing lure systems shown above; and

FIG. 6 is a side view of an alternative embodiment of a treble hook that may be used with the fishing lure systems shown above.

### DETAILED DESCRIPTION OF THE INVENTION

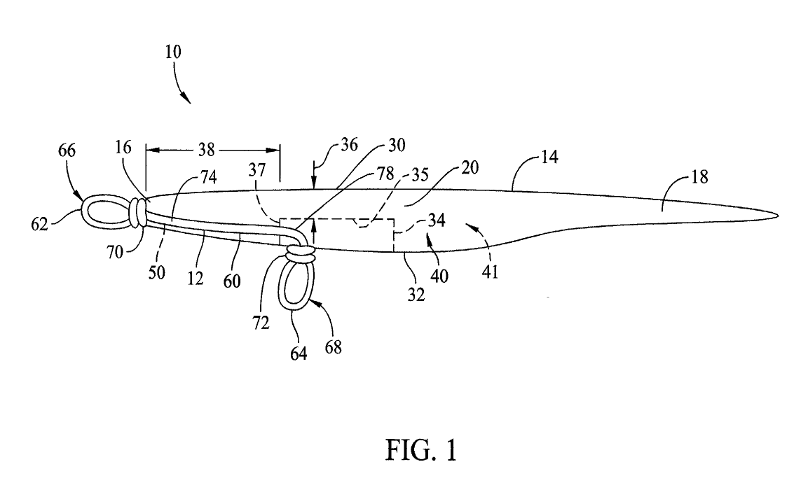

FIG. 1 is a cross-sectional view of one embodiment of a fishing lure system 10 including a rigging harness 12 and a fishing lure 14. Fishing lure 14 is known and in the exemplary embodiment is a seven inch Rainbow Trout Jerk Bait commercially available from Bass Assassin Lures, Inc., Mayo, Fla., 32066. Fishing lure 14 is exemplary only and is not limited to the lure shown. Other lures may be utilized that satisfy the operating parameters described herein while practicing the invention described herein.

Lure 14 is substantially fish-shaped and includes a mouth 16, a tail 18, and a body 20 extending therebetween. Lure 14 is flexible and is known as a soft-lure. Lure body 20 includes a back surface 30 and a lower or stomach surface 32, and has a centerline (not shown) extending between mouth 16 and through tail 18. Body 20 also defines a cavity 34 therein that extends from lower surface 32 towards back surface 30, and from tail 18 towards lure mouth 16. Accordingly, cavity 34 is defined by an upper wall 35 that is a distance 36 from back surface 30, and a forward wall 37 that is a distance 38 from lure mouth 16. Distances 36 and 38, as well as a width (not shown) of cavity 34 measured between opposing sides 40 of lure body 20, are variably selected depending on overall size of rigging harness 12. In an alternative embodiment cavity 34 may also be defined by a rear wall.

An inlet guide opening 50 extends from lure mouth 16 to body cavity 34 through forward wall 37. More specifically, opening 50 extends substantially co-linearly through body 20 with respect to the body centerline.

Rigging harness 12 is formed from a single wire 60 that includes an eye-loop 62 that extends outwardly from lure mouth 16, and at least one rigging loop 64 that extends outwardly from lure lower surface 32. In the exemplary embodiment, wire 60 is a 0.050 inch stainless steel wire that is saltwater ready and has a 500 pound test. More specifically, harness 12 has a front end 66 that extends outwardly from lure mouth 16, and a trailing end 68 that extends outwardly from lure lower surface 32. Wire 60 is continuous between a first end 70 and a second end 72.

In the exemplary embodiment, wire first end 70 is bent to form eye-loop 62 and is twistingly coupled to a shank 74 extending between eye-loop 62 and rigging loop 64 with at least one twist 76. Shank 74 extends rearwardly from eye-loop 62 along the lure centerline and includes an elbow 78 such that loop 64 extends substantially perpendicularly from the lure centerline. Accordingly, wire second end 72 is bent to form rigging loop 64 and is twistingly coupled to shank 74 with at least one twist 76. More specifically, in the exemplary embodiment, wire second end 72 is bent such that rigging loop 64 is substantially co-planar with respect to eye-loop 62, and such that wire ends 70 and 72 remain within lure body 20.

In the exemplary embodiment, lure cavity 34 is initially formed within lure body 20. In one embodiment, a knife is used to form cavity 34. Harness 12 is then formed from wire 60, and is inserted into cavity 34 from lure lower surface 32. Harness 12 is then pushed forward with respect to lure 14 through guide opening 50, such that harness eye-loop 62 is extended outwardly from lure mouth 16, and such that harness shank elbow 78 is adjacent cavity forward wall 37 and harness rigging loop 64 extends outwardly from lure lower surface 32.

During use, a fishing line (not shown) is coupled to harness eye-loop 62, and a variety of fishing paraphernalia (not shown in FIG. 1), including but not limited to hooks and weights are coupled to harness rigging loop 64. Because the hooks hang below lure 14, a natural appearance of fishing lure 14 remains substantially unmarred. Furthermore, because rigging harness 12 is substantially centered with respect to lure 14, as lure 14 is retrieved, rigging harness 12 facilitates lure 14 “swimming” more naturally than other known rigging systems. More specifically, as lure 14 is retrieved, harness 12 enables lure tail 18 to simulate the motion of an actual swimming fish. In addition, coupling weights to harness rigging loop 64 facilitates lure 14 sinking more slowly than other systems in which weights are attached to lure mouth 16. Furthermore, harness 12 is easily exchangeable if a different configuration is desired, or alternatively, harnesses 12 are easily re-installed in a different lure 14 if a different lure 14 is desired.

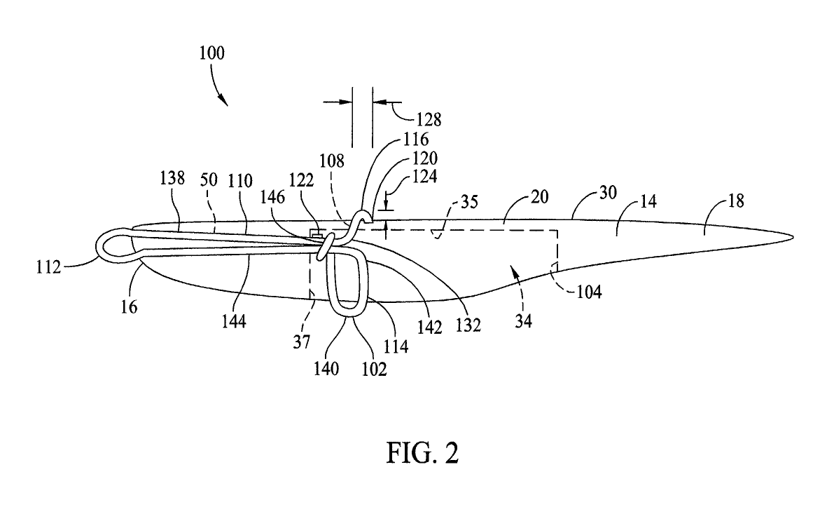

FIG. 2 is a cross-sectional view of an alternative embodiment of a fishing lure system 100. Lure system 100 is substantially similar to lure system 10 (shown in FIG. 1) and components in lure system 100 that are identical to components of lure system 10, are identified in FIG. 2 using the same reference numerals used in FIG. 1. Accordingly, lure system 100 includes a rigging harness 102 and a fishing lure 14. Fishing lure 14 is known and in the exemplary embodiment is a six inch Shad Bait commercially available from Bass Assassin Lures, Inc., Mayo, Fla., 32066. Fishing lure 14 is exemplary only and is not limited to the lure shown. Other lures may be utilized that satisfy the operating parameters described herein while practicing the invention described herein.

Lure 14 includes mouth 16, tail 18, and body 20. Body cavity 34 is defined by upper wall 35, forward wall 37, and a rear wall 104 that in the exemplary embodiment is axially-spaced from and substantially parallel forward wall 37. Dimensions of cavity 34 are variably selected depending on overall size of rigging harness 102. Additionally, inlet guide opening 50 extends from lure mouth 16 to body cavity 34 through forward wall 37. Opening 50 is substantially co-linear through body 20 with respect to the body centerline (not shown).

A barb opening 108 extends from lure back surface 30 to body cavity 34 through cavity upper wall 35. Opening 108 is substantially aligned concentrically along the body centerline.

Rigging harness 102 is formed from a single wire 110 that includes an eye-loop 112 that extends outwardly from lure mouth 16, at least one rigging loop 114 that extends outwardly from lure lower surface 32, and at least one barb 116 that extends outwardly from lure back surface 30. In the exemplary embodiment, wire 110 is a 0.050 inch stainless steel wire that is saltwater ready and has a 500 pound test. Wire 110 is continuous between a wire first end 120 and a second end 122.

In the exemplary embodiment, wire first end 120 is bent to form barb 116. In one embodiment, wire first end 120 is tapered to a form a point. Barb 116 extends outwardly from lure back surface 30 a distance 124. Barb 116 is extended through barb opening 108 such that wire first end 120 contacts lure back surface 30 an axial distance 128 from opening 108 to secure rigging harness 102 within lure 14. Wire 120 is then bent towards lure mouth 16 to form an eye-loop 112. More specifically, an elbow 132 is formed such that barb 116 extends substantially perpendicularly from an upper shank portion 138 of wire 120 extending between elbow 132 and eye-loop 112.

Wire 120 extends axially rearward from eye-loop 112 to form a rigging loop 114. More specifically, an elbow 142 is formed such that rigging loop 114 extends substantially perpendicularly from a lower shank portion 144 of wire extending between elbow 142 and rigging loop 114. In the exemplary embodiment, elbows 132 and 142 are substantially axially aligned.

Rigging loop 114 is twistingly coupled around upper and lower shank portions 138 and 144, respectively, with at least one twist 146. More specifically, wire second end 122 is twisted within twist 146 around shanks 138 and 144. In the exemplary embodiment, wire 120 is bent such that rigging loop 114, barb 116, and eye-loop 112 are substantially co-planar, and such that second wire end 122 remains within lure body 20. In an alternative embodiment, harness 12 includes a plurality of rigging loops 114.

In the exemplary embodiment, lure cavity 34 is initially formed within lure body 20. In one embodiment, a knife is used to form cavity 34. Harness 102 is then formed from wire 120, and is inserted into cavity 34 from lure lower surface 32. Harness 102 is then pushed forward with respect to lure 14 through guide opening 50, such that harness eye-loop 112 is extended outwardly from lure mouth 16. Harness 102 is then pushed upwardly with respect to lure 14 such that barb 116 is forced through barb opening 108, such that wire first end 120 contacts lure back surface 30 to secure harness 102 within lure 14.

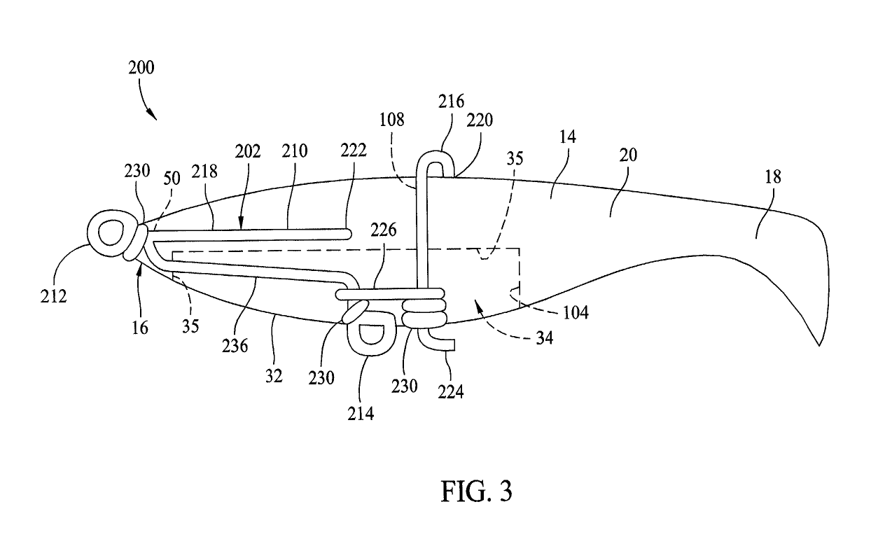

FIG. 3 is a cross-sectional view of an alternative embodiment of a fishing lure system 200. Lure system 200 is substantially similar to lure system 100 (shown in FIG. 2) and components in lure system 200 that are identical to components of lure system 100, are identified in FIG. 3 using the same reference numerals used in FIG. 2. Accordingly, lure system 200 includes a rigging harness 202 and a fishing lure 14. Fishing lure 14 is known and in the exemplary embodiment is a six inch Shad Bait commercially available from K & R, Inc., Birmingham, Ala., 35217. Fishing lure 14 is exemplary only and is not limited to the lure shown. Other lures may be utilized that satisfy the operating parameters described herein while practicing the invention described herein.

Lure 14 includes mouth 16, tail 18, and body 20. Body cavity 34 is defined by upper wall 35, forward wall 37, and a rear wall 104 that in the exemplary embodiment is axially-spaced from and substantially parallel forward wall 37. In an alternative embodiment, cavity 34 is not defined by forward wall 37 and rather cavity 34 is extended through lure mouth 16. Dimensions of cavity 34 are variably selected depending on overall size of rigging harness 202. Additionally, inlet guide opening 50 extends from lure mouth 16 to body cavity 34 through forward wall 37. Opening 50 is substantially co-linear through body 20 with respect to the body centerline (not shown). Furthermore, barb opening 108 extends from lure back surface 30 to body cavity 34 through cavity upper wall 35. Opening 108 is substantially aligned concentrically along the body centerline.

Rigging harness 202 is formed from a single wire 210 that includes an eye-loop 212 that extends outwardly from lure mouth 16, at least one rigging loop 214 that extends outwardly from lure lower surface 32, and at least one barb 216 that extends outwardly from lure back surface 30. Wire 210 also forms a nose pin 218 that is used, as described in more detail below, to facilitate aligning harness 202 with respect to lure 14. In the exemplary embodiment, wire 210 is a 0.050 inch stainless steel wire that is saltwater ready and has a 500 pound test. Wire 210 is continuous between a wire first end 220 and a second end 222.

In the exemplary embodiment, wire first end 220 is bent to form barb 116. In one embodiment, wire first end 220 is tapered to a form a point. Barb 116 extends distance 124 outwardly from lure back surface 30. Barb 116 is extended through barb opening 108 such that wire first end 220 contacts lure back surface 30 an axial distance 128 from opening 108 to secure rigging harness 202 within lure 14. Wire 220 is then bent to form a trailing leader 224 extending outwardly from lure lower surface 32. Trailing leader 224 is twistingly coupled to a cavity shank 226 with at least one twist 230. Shank 226 is substantially perpendicular to barb 116 and extends axially towards lure mouth 16 from twist 230 to form a rigging loop 214. In an alternative embodiment, harness 202 does not include leader 224 and rather wire 220 extends from barb 116 to form rigging loop 214.

Rigging loop 214 is twistingly coupled to a lower shank portion 236 with at least one twist 230. Lower shank portion 236 extends axially towards lure mouth 16 to form an eye-loop 212. More specifically, eye-loop 212 extends outwardly from lure mouth 16, and is twisting coupled to shank portion 236 and nose pin 218 with at least one twist 230. Wire second end 222 extends axially rearward from eye-loop 212 towards barb 116 to form nose pin 218. In the exemplary embodiment, nose pin 218 is substantially perpendicular with respect to barb 116. In the exemplary embodiment, wire 210 is bent such that rigging loop 214, barb 116, eye-loop 212, and nose pin 218 are substantially co-planar, and such that second wire end 222 remains within lure body 20. In an alternative embodiment, harness 202 includes a plurality of rigging loops 214 positioned between barb 116 and eye-loop 212.

In the exemplary embodiment, lure cavity 34 is initially formed within lure body 20. In one embodiment, a knife is used to form cavity 34. Harness 202 is then formed from wire 210, and is inserted into cavity 34 from lure lower surface 32. Harness 202 is then pushed forward with respect to lure 14 through guide opening 50, such that nose pin 218 is substantially co-linear with respect to the body centerline (not shown). Harness 202 is then forced forward with respect to lure 14 until harness eye-loop 212 is extended outwardly from lure mouth 16. Harness 202 is then pushed upwardly with respect to lure 14 to force barb 116 through barb opening 108, such that wire first end 120 contacts lure back surface 30 to secure harness 102 within lure 14.

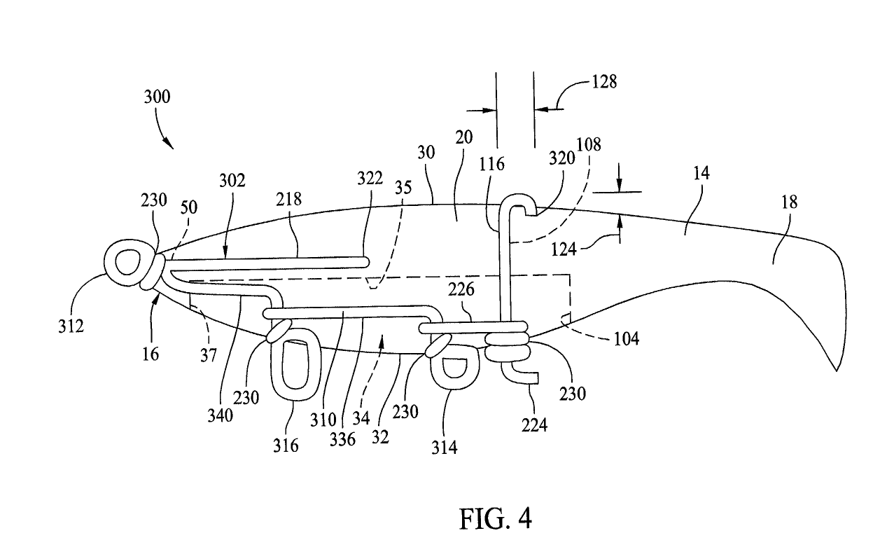

FIG. 4 is a cross-sectional view of an alternative embodiment of a fishing lure system 300. Lure system 300 is substantially similar to lure system 200 (shown in FIG. 3) and components in lure system 300 that are identical to components of lure system 200, are identified in FIG. 4 using the same reference numerals used in FIG. 3. Accordingly, lure system 300 includes a rigging harness 302 and a fishing lure 14. Fishing lure 14 is known and in the exemplary embodiment is a nine inch Shad Bait commercially available from commercially available from K & R, Inc., Birmingham, Ala., 35217. Fishing lure 14 is exemplary only and is not limited to the lure shown. Other lures may be utilized that satisfy the operating parameters described herein while practicing the invention described herein.

Lure 14 includes mouth 16, tail 18, and body 20. Body cavity 34 is defined by upper wall 35, forward wall 37, and rear wall 104. In an alternative embodiment, cavity 34 is not defined by forward wall 37 and rather cavity 34 is extended through lure mouth 16. Dimensions of cavity 34 are variably selected depending on overall size of rigging harness 302. Additionally, inlet guide opening 50 extends from lure mouth 16 to body cavity 34. Opening 50 is substantially co-linear through body 20 with respect to the body centerline (not shown). Furthermore, barb opening 108 extends from lure back surface 30 to body cavity 34 through cavity upper wall 35. Opening 108 is substantially aligned concentrically along the body centerline.

Rigging harness 302 is formed from a single wire 310 that includes an eye-loop 312 that extends outwardly from lure mouth 16, a pair of rigging loops 314 and 316 that extend outwardly from lure lower surface 32, and at least one barb 318 that extends outwardly from lure back surface 30. Wire 310 also forms nose pin 218 and trailing leader 224. In an alternative embodiment, rigging harness 302 includes more than two rigging loops 314 and 316. In a further alternative embodiment, rigging harness 302 does not include trailing leader 224. In yet another alternative embodiment, rigging harness 302 does not include nose pin 218. In the exemplary embodiment, wire 310 is a 0.050 inch stainless steel wire that is saltwater ready and has a 500 pound test. Wire 310 is continuous between a wire first end 320 and a second end 322.

In the exemplary embodiment, wire first end 320 is bent to form barb 116. In one embodiment, wire first end 320 is tapered to a form a point. Barb 116 extends distance 124 outwardly from lure back surface 30. Barb 116 is extended through barb opening 108 such that wire first end 320 contacts lure back surface 30 an axial distance 128 from opening 108 to secure rigging harness 302 within lure 14. Wire 320 is then bent to form trailing leader 224 extending outwardly from lure lower surface 32. Trailing leader 224 is twistingly coupled to a cavity shank 226 with at least one twist 230. Shank 226 is substantially perpendicular to barb 116 and extends axially towards lure mouth 16 from twist 230 to form trailing rigging loop 314.

Rigging loop 314 is twistingly coupled to a lower shank portion 336 with at least one twist 230. Lower shank portion 336 extends axially towards lure mouth 16 to form forward rigging loop 316. Forward rigging loop 316 is twistingly coupled to a forward shank 340 with at least one twist 230. Shank 340 extends axially towards lure mouth 16 from twist 230 to form eye-loop 312. More specifically, eye-loop 312 extends outwardly from lure mouth 16, and is twisting coupled to shank portion 340 and nose pin 218 with at least one twist 230. In an alternative embodiment, eye-loop 312 is not twistingly coupled to shank portion 340 but rather is twistingly coupled to lower shank portion 336.

Wire second end 322 extends axially rearward from eye-loop 312 towards barb 116 to form nose pin 218. In an alternative embodiment, wire second end 322 does not form nose pin 218, but rather extends axially rearward from eye-loop 312 and is twistingly coupled to lower shank portion 336. In the exemplary embodiment, nose pin 218 is substantially perpendicular with respect to barb 116. In the exemplary embodiment, wire 310 is bent such that rigging loops 314 and 316, barb 116, eye-loop 312, and nose pin 218 are substantially co-planar, and such that second wire end 322 remains within lure body 20.

In the exemplary embodiment, lure cavity 34 is initially formed within lure body 20. In one embodiment, a knife is used to form cavity 34. Harness 302 is then formed from wire 310, and is inserted into cavity 34 from lure lower surface 32. Harness 302 is then pushed forward with respect to lure 14 through guide opening 50, such that nose pin 218 is substantially co-linear with respect to the body centerline (not shown). Harness 302 is then forced forward with respect to lure 14 until harness eye-loop 312 is extended outwardly from lure mouth 16. Harness 302 is then pushed upwardly with respect to lure 14 to force barb 116 through barb opening 108, such that wire first end 320 contacts lure back surface 30 to secure harness 302 within lure 14.

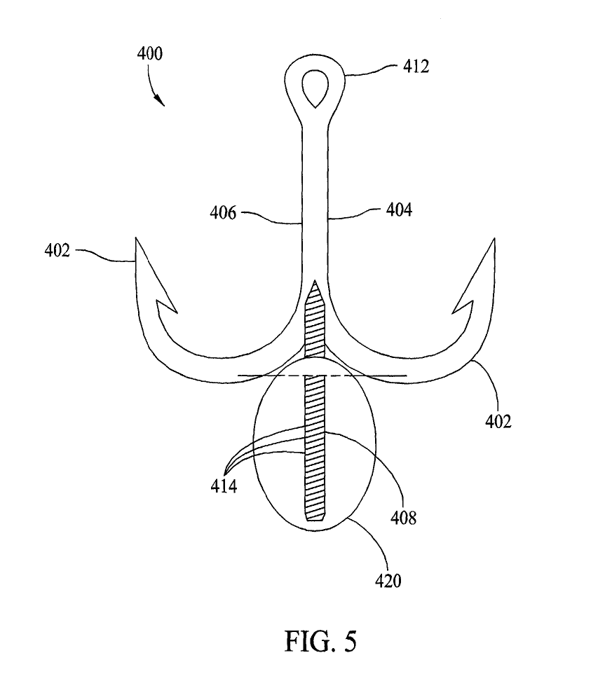

FIG. 5 is a side view of a treble hook 400. Hook 400 may be used, but is not limited to use, with any of the aforementioned fishing lure systems described above, such as lure systems 10, 100, 200, or 300 (shown respectively in FIGS. 1, 2, 3, and 4). Treble hook 400 includes a plurality of barbed hooks 402 that extend outwardly from a center shaft 404. More specifically, shaft 404 includes an attachment portion 406 and a rigging portion 408. Attachment portion 406 includes an eye-loop 412 used to secure hook 400 to other fishing components, such as a line, or a lure system. Hooks 402 extend outwardly from attachment portion 412. In the exemplary embodiment, three hooks 402 extend outwardly from attachment portion 406 and are spaced substantially evenly circumferentially around shaft 404.

Shaft attachment portion 406 extends from eye-loop 412 to shaft rigging portion 408. Shaft rigging portion 408 extends substantially co-axially from attachment portion 406 and includes a plurality of external threads 414 extending along a length of rigging portion 408. In one embodiment, shaft attachment portion 406 is formed integrally with shaft attachment portion 406. In an alternative embodiment, shaft attachment portion 406 is hollow and includes a plurality of threads (not shown) which mate with shaft rigging portion threads 414 to enable rigging portion 408 to couple with attachment portion 406. In a further alternative embodiment, shaft rigging portion 408 is coupled to shaft attachment portion 406 by a coupling process, such as, but not limited to, soldering, gluing, or welding.

Shaft rigging portion 408 enables weights 420 to be threadingly coupled to hook 400. More specifically, each weight 420 includes a threaded bore 422 that is sized to enable each weight 420 to threadingly couple with shaft rigging portion 408. In an alternative embodiment, each weight includes a threaded shaft (not shown) which is received within a hollow threaded shaft rigging portion. Shaft rigging portion 408 enables weights 420 to be removably coupled to hook 400 and thus facilitates replacing and exchanging weights in an efficient manner. Furthermore, rigging portion 408 enables weights 420 to be attached such that each weight 420 extends substantially co-axially from shaft attachment portion 406.

In an alternative embodiment, hook 400 does not include shaft rigging portion 408 and rather weights 420 are coupled substantially co-axially to shaft attachment portion 406 by wires (not shown) which are routed through eye-loop 412 and around weights 420. In a further alternative embodiment, hook 400 does not include shaft rigging portion 408, weights 420 include a bore (not shown) extending therethrough, and weights 420 are coupled substantially co-axially to shaft attachment portion 406 by wires (not shown) which are routed through eye-loop 412 and through the weight bore. In yet another alternative embodiment, hook 400 does not include shaft rigging portion 408, but rather weights 420 are coupled substantially co-axially to shaft attachment portion 406 by wires (not shown) which are routed through eye-loop 412 and through hollow shaft 404 and around weights 420.

The above-described lure systems are cost-effective and highly reliable. The lure systems include a rigging system that is formed from a single wire that is inserted at least partially within a lure body. The wire is bent to form at least an eye-loop that is used to attach the lure to a line and at least one rigging loop that extends outwardly from a lower surface of the lure and is used to attach fishing paraphernalia to the lure. Because a plurality of wires are not used to form the harness, the harness does not include weak attachment points that other known harnesses include. Furthermore, because the harness enables fishing paraphernalia to be attached below the fishing lure, the harness facilitates the fishing lure swimming with a more natural motion than other known fishing lure systems. In addition, the harnesses are easily interchangeable in a cost-effective and reliable manner.

Exemplary embodiments of lure systems and treble hooks are described above in detail. The systems are not limited to the specific embodiments described herein, but rather, components of each system may be utilized independently and separately from other components described herein. Each lure system component can also be used in combination with other lure system components.

While the invention has been described in terms of various specific embodiments, those skilled in the art will recognize that the invention can be practiced with modification within the spirit and scope of the claims.

What is claimed is:

1. A rigging harness for a fishing lure, said rigging harness comprising a single wire comprising an eye-loop and at least one loop, said loop axially spaced from said eye-loop, said rigging harness configured to be inserted at least partially within the fishing lure such that said eye-loop extends outwardly from the fishing lure when said rigging harness is secured to the lure.

2. A rigging harness in accordance with claim 1 wherein said wire further comprises a barb for securing said rigging harness within the lure.

3. A rigging harness in accordance with claim 2 wherein said barb extends substantially perpendicularly from said eye-loop.

4. A rigging harness in accordance with claim 2 wherein said barb extends outwardly from the fishing lure.

5. A rigging harness in accordance with claim 2 wherein said at least one loop between said barb and said eye-loop.

6. A rigging harness in accordance with claim 2 wherein said at least one loop further comprises a plurality of loops.

7. A rigging harness in accordance with claim 6 wherein said plurality of loops between said barb and said eye-loop.

8. A rigging harness in accordance with claim 2 wherein said barb configured to extend from a back of the lure.

9. A rigging harness in accordance with claim 1 where said wire further comprises a nose pin extending from said eye-loop.

10. A rigging harness in accordance with claim 1 wherein said at least one loop further comprises a plurality of loops.

11. A rigging harness in accordance with claim 1 wherein said eye-loop configured to extend from a nose of the lure.

12. A rigging harness in accordance with claim 1 wherein said at least one loop configured to extend from a lower surface of the lure.

13. A rigging harness in accordance with claim 1 wherein said system configured to couple the lure to a line.

14. A fishing lure system comprising:
a lure comprising a fish-shaped body comprising a mouth, a tail, and a body extending therebetween, said body comprises a back surface and a lower surface, and has a cavity defined therein; and
a rigging harness configured to couple said lure to a line, said rigging harness comprising a single wire comprising an eye-loop and at least one loop, said loop axially spaced from said eye-loop, said rigging harness inserted partially within said lure cavity such that said eye-loop extends outwardly from said lure mouth when said rigging harness coupled to said lure.

15. A fishing lure system in accordance with claim 14 wherein said lure has a centerline extending between said lure mouth and tail, said rigging harness extending substantially co-linearly along said lure centerline.

16. A fishing lure system in accordance with claim 14 wherein said at least one loop configured to extend outwardly from said lure lower surface.

17. A fishing lure system in accordance with claim 14 further comprising a barb for securing said rigging harness to said lure.

18. A fishing lure system in accordance with claim 17 wherein said barb extends outwardly from said lure back surface.

19. A fishing lure system in accordance with claim 17 wherein said rigging harness at least one loop between said barb and said eye-loop.

20. A fishing lure system in accordance with claim 17 wherein said rigging harness at least one loop further comprises a plurality of loops.

21. A fishing lure system in accordance with claim 20 wherein said rigging harness plurality of loops between said barb and said eye-loop.

22. A fishing lure system in accordance with claim 14 wherein said at rigging harness at least one loop further comprises a plurality of loops.

23. A fishing lure system in accordance with claim 14 wherein said rigging harness at least one loop configured to attach fishing paraphernalia to said lure.

24. A method for fabricating a fishing lure system, said method comprising:
providing a fishing lure having a fish-like body including a mouth and a tail;
forming a rigging harness from a single wire to include an eye-loop and at least one loop that is axially-spaced from the eye-loop;
inserting the rigging harness within the fishing lure; and
coupling the rigging harness to the lure such that the eye-loop extends outwardly from the fishing lure mouth and the at least one loop extends outwardly from the lure body.

25. A method in accordance with claim 24 wherein forming a rigging harness further comprises bending the wire to form the eye-loop and the at least one loop.

26. A method in accordance with claim 24 wherein coupling the rigging harness to the lure further comprises inserting the rigging harness into a cavity formed within the fishing lure.

27. A method in accordance with claim 24 wherein the fishing lure body has a centerline extending between the mouth and the tail, inserting the rigging harness within the fishing lure further comprises inserting the rigging harness into the fishing lure such that the rigging harness extends substantially co-linearly along the fishing lure centerline.

28. A method in accordance with claim 24 wherein forming a rigging harness from a single wire further comprises forming a rigging harness from a single wire to also include a securing barb.

29. A method in accordance with claim 28 wherein inserting the rigging harness within the fishing lure further comprises inserting the rigging harness within the fishing lure such that the barb extends outwardly from a back surface of the fishing lure body while the at least one hook extends outwardly from a lower surface of the lure body.

30. A method in accordance with claim 28 wherein inserting the rigging harness within the fishing lure further comprises securing the rigging harness to the fishing lure with the barb.

31. A method in accordance with claim 28 wherein forming a rigging harness further comprises bending the wire such that the at least one loop is between the barb and the eye-loop.

32. A method in accordance with claim 28 wherein forming a rigging harness further comprises bending the wire to form a plurality of loops.

33. A method in accordance with claim 28 wherein forming a rigging harness further comprises bending the wire to form a plurality of loops between the barb and the eye-loop.

34. A method in accordance with claim 24 wherein forming a rigging harness further comprises bending the wire to form a plurality of loops.

35. A method in accordance with claim 24 further comprising attaching a treble hook to the rigging harness.

36. A method in accordance with claim 35 wherein attaching a treble hook to the rigging harness further comprises attaching a weight to the treble hook.

37. A method in accordance with claim 35 wherein attaching a treble hook to the rigging harness further comprises threadingly coupling a weight to the treble hook.

38. A method in accordance with claim 35 wherein the treble hook has three hooks extending outwardly from a shaft, attaching a treble hook to the rigging harness further comprises attaching a weight to the treble hook such that the weight is substantially coaxially aligned with respect to the shaft portion of the treble hook.

39. A fishing hook comprising a shaft portion, a hook portion, and a weight-coupling portion, said hook portion extending from said shaft portion and comprising a plurality of hooks extending outwardly from said hook portion, said shaft portion configured to removably couple with a weight such that said weight extends substantially coaxially from said shaft portion.

40. A fishing hook in accordance with claim 39 wherein said shaft portion further comprises a first end and a second end, said first end comprising an eyelet, said weight configured to couple with said second end.

41. A fishing hook in accordance with claim 40 wherein said shaft portion second end comprises a plurality of threads, said weight configured to threadingly couple with said shaft portion second end.

42. A fishing hook in accordance with claim 41 wherein said weight coupled to said shaft portion with a wire.

43. A fishing hook in accordance with claim 42 wherein said wire extends around said weight and through said shaft portion eyelet.

44. A fishing hook in accordance with claim 41 wherein said shaft portion second end is hollow.
